(19) United States
(12) Patent Application Publication
(10) Pub. No.: US 2026/0200001 A1
(43) Pub. Date: Jul. 16, 2026

(54) Joining Method And Joining Device For Joining Workpieces

(71) Applicant: Newfrey LLC, New Britain, CT (US)

(72) Inventors: Michael BLOECHER, Giessen (DE); Alexander Hofmann, Giessen (DE)

(73) Assignee: Newfrey LLC, New Britain, CT (US)

(21) Appl. No.: 19/559,241

(22) Filed: Mar. 6, 2026

Related U.S. Application Data
(63) Continuation of application No. PCT/EP2024/074871, filed on Sep. 5, 2024.

(30) Foreign Application Priority Data
Sep. 8, 2023 (EP) 23196218.4

(51) Int. Cl. B23K 10/02; B23K 37/04

(52) U.S. Cl. CPC B23K 10/02; B23K 37/0435

(57) ABSTRACT

Joining method for joining at least two workpieces with a joining device. The joining device has a retaining device for a joining element, a clamping device, and a thermal device. The joining element can be guided along or arranged on a joining axis via the retaining device. With the clamping device, one or more workpieces can be compressed in a joining direction. The thermal device is arranged on the clamping device and moves together with the clamping device.

### CROSS-REFERENCE TO RELATED APPLICATIONS

This application is a bypass continuation of International Application No. PCT/EP2024/074871, filed on September 5, 2024, which claims the benefit and priority of European Application No. 23196218.4, filed on September 8, 2023. The entire disclosure of each of the above applications is incorporated herein by reference.

### FIELD

The present disclosure relates to a joining device, in particular a joining device adapted to join a workpiece arrangement (for instance at least two sheet or workpieces arranged one above the other) with a joining element and without preformed (for example pre-drilled or pre-punched) hole or holes in the component prior to the joining and comprising a clamping device. The present disclosure also relates to a process for joining a workpiece arrangement.

### BACKGROUND

This section provides background information related to the present disclosure which is not necessarily prior art.

Joining methods and joining devices of the above-mentioned kind are widely known, especially in the field of clinching, resistance welding, punch riveting or direct screwing, and are used for example in automotive engineering.

It is known to use during a mechanical joining process a joining device with a punch with which a linear setting movement can be executed, and a clamping device. The clamping device ensures different functions such as pressing together the members of a workpiece arrangement to avoid any gap between the workpieces, avoiding a possible displacement of adhesive between the workpieces, and reducing the workpiece deformation during the joining process.

The joining devices known usually comprise a clamping device attached to a setting punch via a spring and moved with it. Document DE 10 2005 031917 A1 discloses a method for joining in which, in a first step, a main piston and a clamping device are pressed against the workpieces with a comparatively low force, so that the workpieces are held immovably in contact with one another and with a die.

In joining technology processes, it can be advantageous if the workpieces to be joined are partially heated before the setting process. US2024238922A1 discloses a joining device using a light source and a light guiding system, the light guiding system being provided at a front end of a joining head. CN104607557A discloses an ignition device arranged on the retaining device or receiver of a self-punching riveting device. DE102019108813A1 discloses a process for joining components or workpieces with a conductive heating step. In DE102018202140A1, an induction coil or an electrode is used to heat a joining element configured to be set in a workpiece arrangement. Thermal devices such as plasma torches are also used for this heating. EP3515632A1 from the applicant discloses for instance such process. The thermal device is usually permanently mounted to the housing of the joining device.

When positioning the thermal device, a defined distance between the thermal device and the component must be maintained. If the distance is not maintained, several problems can occur. For example, fluctuations in energy transfer to the workpiece lead to joining area too cold or too hot, which compromises the quality of the joining. Besides, since the thermal device, such as a plasma torch or plasma burner, usually has to be mounted at an angle with regard to the surface of the workpiece, due to space requirements, the workpiece may be heated outside the joining area. Finally, due to component variations or robot positioning errors, the position of the thermal device relative to the workpiece may not be constant. Small changes in the workpiece position (distance of the thermal device) lead to position shifts of the heated zone. The joining element may not be placed in the heated zone.

It is therefore necessary to improve the existing joining device and joining method to avoid these drawbacks.

### SUMMARY

This section provides a general summary of the disclosure, and is not a comprehensive disclosure of its full scope or all of its features.

An object of the present disclosure is therefore to provide a joining device which is flexible, compact and a joining method by means of which the joining process can be better controlled and hence performed more effectively.

Accordingly, the present disclosure provides a joining device and a joining method. More particularly, the joining device for joining workpieces comprises a joining head having:

a retaining device for a joining element, wherein the joining element can be guided along or arranged on a joining axis via the retaining device;

a clamping device with which one or more workpieces can be compressed in a joining direction; and

a thermal device,

wherein the thermal device is arranged on the clamping device and moves together with the clamping device.

Mounting the thermal device on the clamping device allows the distance between the thermal device and the workpiece to be changed during the joining process. Thus, this increases the flexibility of the joining device, since adjustment can be made to the position of the thermal device relative to the workpiece. The clamping device is independent from the retaining device such that the force applied by the clamping device on the workpiece arrangement is not linked to the joining process and the position of the retaining device.

In an embodiment, the thermal device is a plasma torch. More particularly, the plasma torch delivers a non-thermal plasma, with rather low temperatures between 30 and 700 degrees Celsius. It is a non-transferred arc. It is under atmospheric pressure.

In an embodiment, the thermal device is movably arranged on the clamping device. When heating the components, it can be advantageous to press the workpieces to be joined together during heating (heat conduction from the upper layer to the lower layer of the workpiece arrangement) or not to press them together (the upper workpiece is then heated more).

In an embodiment, the thermal device is movable on the clamping device between a first position, in which the clamping device is adapted to contact the workpiece and the thermal device extends at a first predetermined position from the workpiece, and a second position, in which the clamping device is adapted to be at a non-zero distance from the workpiece and the thermal device extends at a second predetermined position from the workpiece. Thus, the distance between the thermal device and the workpiece arrangement may or may not remain the same when the clamping element contacts the workpiece or not. In another embodiment, the thermal device is fixedly arranged on the clamping device.

In an embodiment, the thermal device is controlled and driven by a dedicated thermal drive unit. The thermal device may thus be independently controlled on the clamping device.

In an embodiment, the clamping device is spring loaded. In other embodiments, the clamping device may also be electrically or pneumatically or hydraulically driven.

In an embodiment, the clamping device is controlled and moved by a dedicated clamping drive unit. The clamping device can be controlled on force or displacement, and in addition with possible with time-delay. The clamping device can apply, during the setting steps of the joining element different clamping forces to or displacement with regard to the workpieces.

In an embodiment, the clamping drive unit comprises a displacement measurement system, for example a displacement encoder adapted to determine the distance between a workpiece and the thermal device. Thus, the clamping device is used to find and record the position of the workpiece.

The present disclosure is also directed to a joining method for joining at least two workpieces with a joining device comprising the following steps of:

providing a workpiece arrangement comprising an upper workpiece and a lower workpiece,

providing a joining device, the joining device being arranged at a non-zero distance above the workpiece arrangement;

using the thermal device to heat the workpiece arrangement, wherein the thermal device may be used in two different positions of the clamping device;

setting a joining element into the workpiece arrangement.

When heating the components, it can be advantageous to press the workpieces to be joined together during heating (heat conduction from the upper layer to the lower layer of the workpiece arrangement) or not to press them together (the upper workpiece is then heated more).

In an embodiment, a heating step is undertaken when the clamping device is at a non-zero distance from the workpiece arrangement. It allows to heat more the upper workpiece of the workpiece arrangement facing the joining device.

In an embodiment, a heating step is undertaken when the clamping device contacts the workpiece. This allows to optimize the heat transfer between a first and a second workpiece.

In an embodiment, the thermal device is arranged movable on the clamping device between a first and a second position. In the first position the clamping device contacts the workpiece, and the thermal device extends at a first predetermined position from the workpiece. In the second position, the clamping device is at a non-zero distance from the workpiece and the thermal device extends at a second predetermined position from the workpiece. The first and second predetermined position may be similar or different, depending on the results to be achieved during the heat treatment.

In an embodiment, a displacement measurement system, for example a displacement encoder determines the distance between the thermal device and the workpiece arrangement. The displacement encoder may be provided on or in the clamping drive unit.

In an embodiment, the clamping device is moved down up to the workpiece arrangement and until it contacts the workpiece arrangement, a contact position corresponding to the position in which the clamping device contacts the workpiece arrangement is saved by a controller in order to be used for further setting steps.

In an embodiment, the distance between the thermal device and the workpiece arrangement may be determined and corrected before and during the setting steps. Thus, a control may occur to ensure a correct heating of the workpiece thorough the process.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 schematically shows a joining device according to the invention with a retaining device comprising a joining element, a clamping device and a thermal device, wherein the clamping device clamps a workpiece arrangement, and the thermal device is in a first position.

FIG. 2 schematically shows the joining device of FIG. 1, wherein the clamping device is at distance from the workpiece arrangement and the thermal device is in a second position.

Corresponding reference numerals indicate corresponding parts throughout the several views of the drawings.

### DETAILED DESCRIPTION

Example embodiments will now be described more fully with reference to the accompanying drawings.

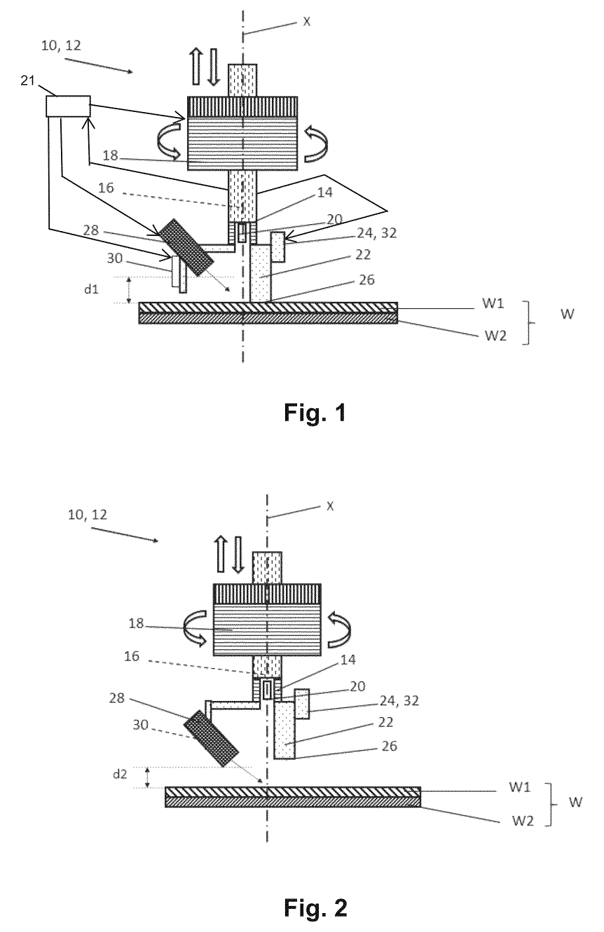

FIGS. 1 and 2 show schematically a joining device 10. The joining device 10 is adapted to carry out a method for joining a workpiece arrangement W comprising at least a first and a second workpiece W1, W2 (or sheet) arranged one above the other, together with a joining element 20. The joining device 10 comprises a joining head 12, which can be moved freely in the space by means of a robot (not represented). The joining head 12 being for instance mounted on one arm of the robot. The joining device 10 or joining head 12 comprises a retaining device 14. The retaining device 14 is adapted to retain and guide or arrange the joining element 20 along a joining axis X for its setting into the workpiece arrangement W. The joining element 20 may be a punch rivet, a self-piercing rivet or a pin or a screw.

The joining device 10 may comprise a punch 16 for with which a linear setting movement of the joining element can be executed, the punch 16 being movable along the joining axis by a drive unit 18 (e.g., an actuator). The retaining device 14, the punch 16 and the drive unit 18 may be arranged longitudinally extending along the joining axis X. The punch 16 may be adapted to penetrate the retaining device 14 in order to drive the joining element 20 toward and into the workpiece arrangement W. The punch 16 allows a linear setting movement of the joining element 20. The punch 16 is movable along the joining axis X, notably by the drive unit 18. A controller 21 may control the drive unit 18 to move the punch 16.

The joining device 10 further comprises a clamping device 22 adapted to compress or press the workpiece arrangement in the joining direction. The clamping device 22 may be movable and controlled by the drive unit 18. For instance, the clamping device 22 may be spring-loaded. The clamping device 22 may also be moved or controlled by a dedicated clamping drive unit 24 (e.g., an actuator), different from the drive unit 18. The controller 21 may control the drive unit 18 or the drive unit 24 to move the clamping device 22.

The clamping device 22 may comprise a surface detection unit (or sensor) 26 adapted to detect an upper surface of the workpiece arrangement W. The surface detection unit 26 may comprise a laser adapted to measure without contact the distance from the workpiece, or a capacitive sensor or an inductive sensor or any other contactless proximity sensor. Alternatively, the surface detection unit 26 may comprise a device for a mechanical or touch measurement for tactile surface recognition. For example, a force increase or a relative displacement between the punch and the retaining device may be used for contact detection.

The joining device 10 comprises a thermal device 28. The thermal device 28 is arranged on the clamping device 22. More particularly, the clamping device 22 may comprise a recess or a portion adapted to receive or connect the thermal device 28 directly to the clamping device 22. The thermal device 28 is for instance a plasma torch. The plasma torch will thermally assist the joining process. Patent publication EP3515632A1 from the applicant explains for instance how the plasma torch may assist the joining process.

The thermal device 28 may be fixedly (or immovably) fixed to the clamping device 22 or may be movably fixed to the clamping device 22.

FIG. 1 shows the clamping device 22 in contact with the workpiece arrangement W, and the thermal device 28 in a first position with regard to the clamping device 22.

FIG. 2 shows the clamping device 22 at a non-zero distance from the workpiece arrangement W and the thermal device 28 in a second position with regard to the clamping device 22.

The thermal device 28 may be controlled and driven with regard to the clamping device 22 by a dedicated thermal drive unit 30 (e.g., an actuator). The thermal drive unit 30 moves the thermal device 28 from its first position to its second position and vice-versa. The controller 21 may control the position of the thermal device 28 (e.g., via the thermal drive unit 30), depending either on the position of the clamping device 22 or on predetermined joining method parameters. The controller 21 may turn on or off the thermal device 28, either directly or indirectly via the thermal drive unit 30.

The clamping device 22, and more particularly the drive unit 18, 24 controlling the clamping device 22 (either the drive unit 18 or the clamping drive unit 24), may comprise a displacement measurement system (or sensor) 32, for example a displacement encoder, adapted to determine the distance between a workpiece and the clamping device 22. Thus, indirectly, the distance between the thermal device 28 and the workpiece arrangement W may also be controlled and modified if necessary. The displacement measurement system 32 may output the position of the clamping device 22 to the controller 21.

The joining device 10 may be used, as mentioned above, to join workpieces of a workpiece arrangement, according to the following steps.

In a first step, the joining device 10 is arranged (for instance by the robot mentioned above) above the workpiece arrangement W. The joining device 10 does not contact the workpiece arrangement W. The joining device 10 comprises the joining element 20. The workpiece arrangement W comprises at least two workpieces (or sheets) W1, W2 arranged one above the other. Optionally, an adhesive is provided between the two workpieces.

In a second step, the clamping device 22 and the thermal device 28 are moved toward the workpiece arrangement W until the clamping device 22 contacts the upper surface of the workpiece arrangement W (e.g., via the controller 21 controlling the drive unit 18 or 24). The thermal device 28 is then turned on (e.g., by the controller 21) to heat up the workpiece arrangement W. After or concurrent with the second step and before the thermal device 28 is turned on, the thermal device 28 may be moved relative to the clamping device 22, for example, from its first position to its second position (e.g., via the controller 21 controlling the thermal drive unit 30).

In a third step, the joining element 20 can be set into the workpiece arrangement W, for instance by the punch 16 (e.g., via the controller 21 controlling the drive unit 18). The joining element 20 is pressed through the at least two workpieces W1, W2 with a determined setting force.

In a last step, the clamping device 22 is moved back to an exit position (e.g., via the controller 21 controlling the drive unit 18 or 24). Thus, the next joining element may be used for the next setting process.

The joining device 10 as described above allows the introduction of a “workpiece finding” stroke. During this stroke, the clamping device 22 is moved until it contacts the upper surface of the workpiece arrangement W. The detection of the upper surface of the workpiece arrangement W may be done with a mechanical contact measurement. A contact sensor can be used. Alternatively, a force increase or a relative displacement between the punch 16 and the retaining device may be used for contact detection. The position of the upper surface of the workpiece arrangement W (and/or the position of the clamping device 22 when it contacts the upper surface of the workpiece arrangement W) can then be stored by the controller 31 and be used by the controller 31 in the subsequent steps such as the joining element setting step or heating step to better control and determine the joining parameters.

As mentioned above, the thermal device 28 may be movable on the clamping device 22 between two different positions.

For instance, in the first position (visible in FIG. 1) the clamping device contacts the workpiece arrangement W (and press the workpiece arrangement) and the thermal device 28 heats the workpiece arrangement. The thermal device is arranged at a first predetermined distance d1 from the workpiece arrangement. The heat transfer from the upper workpiece to the lower workpiece is increased by the clamping. When the clamping device 22 contacts the workpiece, the position of the thermal device 28 with regard to the workpiece may be determined via the position of the clamping device 22.

In the second position (depicted in FIG. 2), the clamping device 22 does not contact the workpiece arrangement W. The thermal device 28 is arranged at a second predetermined distance d2 from the workpiece arrangement. The second predetermined distance may be the same as the first predetermined distance d1, due to the different position of the thermal device 28 on the clamping device 22. The heat transfer between the upper workpiece and the lower workpiece is reduced, since the workpieces are not pressed by the clamping device 22. When the thermal device 28 is mounted in the second position, after an optional “workpiece finding” stroke as depicted above, the clamping device 22 may be retracted (e.g., via the controller 21 controlling the drive unit 18 or 24) by a predetermined distance corresponding to the optimal distance for the thermal device 28 for heating the workpieces. The distance d2 between the thermal device 28 and the upper surface of the workpiece arrangement W may be determined via the displacement encoder 32 of the drive unit 24 or clamping drive unit 24.

joining device 10

workpiece arrangement W

a first and a second workpiece W1, W2

joining head 12

retaining device 14

punch 16

drive unit 18

joining axis X

joining element 20

clamping device 22

clamping drive unit 24

surface detection unit 26

thermal device 28

thermal drive unit 30

displacement measurement system 32

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A joining device for joining workpieces, the joining device comprising a joining head having: a retaining device for a joining element, wherein the joining element can be guided along or arranged on a joining axis via the retaining device; a clamping device with which one or more workpieces can be compressed in a joining direction; and a thermal device configured to heat treat the one or more workpieces, wherein the thermal device is a plasma torch arranged on the clamping device and moves together with the clamping device.

2. The joining device according to claim 1, wherein the thermal device is movably arranged on the clamping device.

3. The joining device according to claim 1, wherein the thermal device is fixedly arranged on the clamping device.

4. The joining device according to claim 2, wherein the thermal device is movable on the clamping device between a first position, in which the clamping device is adapted to contact the workpiece and the thermal device extends at a first predetermined position from the workpiece, and a second position, in which the clamping device is adapted to be at a non-zero distance from the workpiece and the thermal device extends at a second predetermined position from the workpiece.

5. The joining device according to claim 1, wherein the clamping device is spring loaded or electrically or pneumatically or hydraulically controlled.

6. The joining device according to claim 1, wherein the clamping device is controlled and moved by a dedicated clamping drive unit.

7. The joining device according to claim 6, wherein the clamping drive unit comprises a displacement measurement system adapted to determine the distance between a workpiece and the thermal device.

8. A joining method for joining at least two workpieces with a joining device, the joining method comprising: providing a workpiece arrangement comprising an upper workpiece and a lower workpiece; providing a joining device, the joining device including a clamping device being arranged at a non-zero distance above the workpiece arrangement; using a thermal device to heat the workpiece arrangement; and setting a joining element into the workpiece arrangement.

9. The joining method according to claim 8, wherein a heating step is undertaken when the clamping device is at a non-zero distance from the workpiece arrangement.

10. The joining method according to claim 8, wherein a heating step is undertaken when the clamping device contacts the workpiece.

11. The joining method according to claim 8, further comprising moving the thermal device on the clamping device between a first position and a second position, and wherein in the first position, the clamping device contacts the workpiece and the thermal device extends at a first predetermined position from the workpiece, and in the second position, the clamping device is at a non-zero distance from the workpiece and the thermal device extends at a second predetermined position from the workpiece.

12. The joining method according to claim 8, further comprising using a displacement measurement device to determine the distance between the thermal device and the workpiece arrangement.

13. The joining method according to claim 8, further comprising moving the clamping device toward the workpiece arrangement until it contacts the workpiece arrangement, and saving, by a controller, a contact position corresponding to the position in which the clamping device contacts the workpiece arrangement for use in further setting steps.

14. The joining method according to claim 8, wherein the distance between the thermal device and the workpiece arrangement is determined and corrected before and during the setting step.
